(19) United States
(12) Patent Application Publication
(10) Pub. No.: US 2013/0135397 A1
(43) Pub. Date: May 30, 2013

(54) INKJET RECORDING APPARATUS

(71) Applicant: Riso Kagaku Corporation, Tokyo (JP)

(72) Inventors: Asayo NISHIMURA, Ibaraki-ken (JP); Toshihiro ENDO, Ibaraki-ken (JP)

(73) Assignee: Riso Kagaku Corporation, Tokyo (JP)

(21) Appl. No.: 13/681,477

(22) Filed: Nov. 20, 2012

(30) Foreign Application Priority Data
Nov. 29, 2011 (JP) 2011-260524

(51) Int. Cl. B41J 2/045

(52) U.S. Cl. CPC B41J 2/0454
USPC 347/57

(57) ABSTRACT

When a non-aqueous ink having a high density is used, a physical quantity defined as “density/viscosity” is equal to or more than a reference value, and therefore printing on a recording sheet is performed using a drive signal with a waveform for suppressing a residual vibration of the ink. Likewise, as to an ink having a low density, when the viscosity of the ink is low, the physical quantity is equal to or more than the reference value, and therefore printing on a recording sheet is performed using the drive signal with a waveform for suppressing a residual vibration of the ink. On the contrary, when the physical quantity is less than the reference value, printing on a recording sheet is performed using the drive signal with a normal waveform.

### BACKGROUND OF THE INVENTION

1. Technical Field

The present invention relates to an inkjet recording apparatus that ejects an ink within an ink chamber from a nozzle communicated with the ink chamber by increasing or decreasing the pressure on the ink within the ink chamber.

2. Background Arts

In the inlet recording apparatus, an ink is ejected from a nozzle by applying a pressure to the ink within the ink chamber by contracting the ink chamber provided at an inkjet head after expanding by a drive pulse for a predetermined period of time. At this time, if a residual vibration occurs in the ink that remains within the ink chamber, it is not possible to apply a sufficient pressure to the ink when ejecting the ink from the ink chamber the next time, and thus the ink ejection performance is reduced. Therefore, after ink is ejected, the ink chamber is expanded (or contracted) after contracting (or expanding) for a fixed period of time by a cancel pulse to cancel the above-described residual vibration.

As to this technique, Japanese Patent Application Laid-Open No. 9-123445 proposes to make an attempt to optimize the cancellation of residual vibration by adjusting the timing and pulse width of a cancel pulse in accordance with the density of ink that differs depending on the ink color.

### SUMMARY OF THE INVENTION

However, there is an ink for which suppression of residual vibration is not necessary depending on the density. If a cancel pulse intended to suppress residual vibration is applied to such an ink, there occurs such trouble that the amount of ejected ink is reduced compared to the normal amount. Therefore, a technique to appropriately apply the cancel pulse intended to suppress residual vibration will be important.

An object of the present invention is to provide an inkjet recording apparatus capable of appropriately applying a cancel pulse intended to suppress residual vibration to ejection of an ink.

In order to achieve the above-mentioned object, there is provided an inkjet recording apparatus comprising: a volume changer configured to eject ink from a nozzle by applying a drive signal to an ink chamber communicated with the nozzle to change the volume of the ink chamber and thereby to increase or decrease the pressure on the ink to be supplied to the ink chamber, a comparator configured to compare a value of a physical quantity in proportion to the density of the ink to be supplied selectively to the ink chamber with a predetermined reference value; and a drive signal application unit configured to apply a first drive signal to the volume changer, the first drive signal including a cancel pulse to suppress the residual vibration of the pressure on the ink within the ink chamber, when the physical quantity exceeds the reference value, or to apply a second drive signal not including the cancel pulse to the volume changer when the physical quantity is less than the reference value, wherein the when a first drive signal is applied, the volume changer changes the volume of the ink chamber so that the fluctuation of the pressure on the ink within the ink chamber after the application of the first drive signal is completed is cancelled.

### BRIEF DESCRIPTION OF THE DRAWINGS

FIG. 1 is a diagram showing an outline of a configuration of an inkjet printer according to an embodiment of the present invention.

FIG. 2 is a diagram showing a general configuration of each ink circulation system printing unit.

FIG. 3 is a diagram showing specifications of ink with which each ink cartridge of FIG. 2 is filled.

FIGS. 4A and 4B show a change in physical properties by temperature of a non-aqueous based ink and a current ink (oil ink) of FIG. 3. FIG. 4A is a graph showing a change in density and FIG. 4B is a graph showing a change in viscosity.

FIG. 5 is a perspective view showing an outline of a configuration of an inkjet head of FIG. 2 by a partial section.

FIG. 6 is a section view along VI-VI line of an ink supply unit of the inlet head shown in

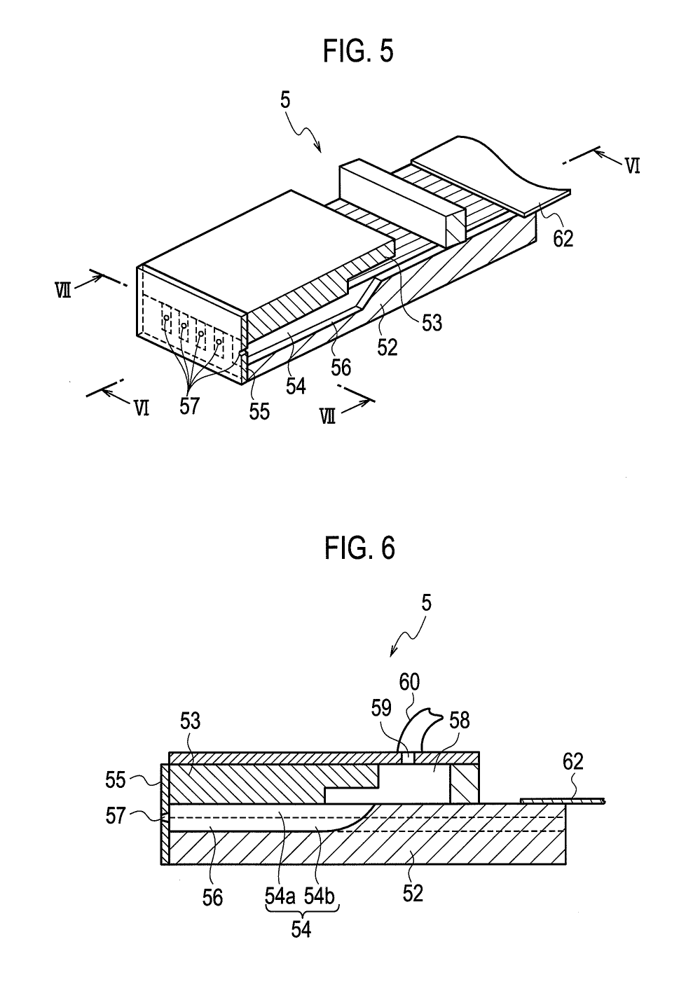

FIG. 5.

FIGS. 7A to 7C are section views along VII-VII line of the ink supply unit of the inkjet head shown in FIG. 5, each showing a change of the state within the ink chamber at the time of ink ejection operation.

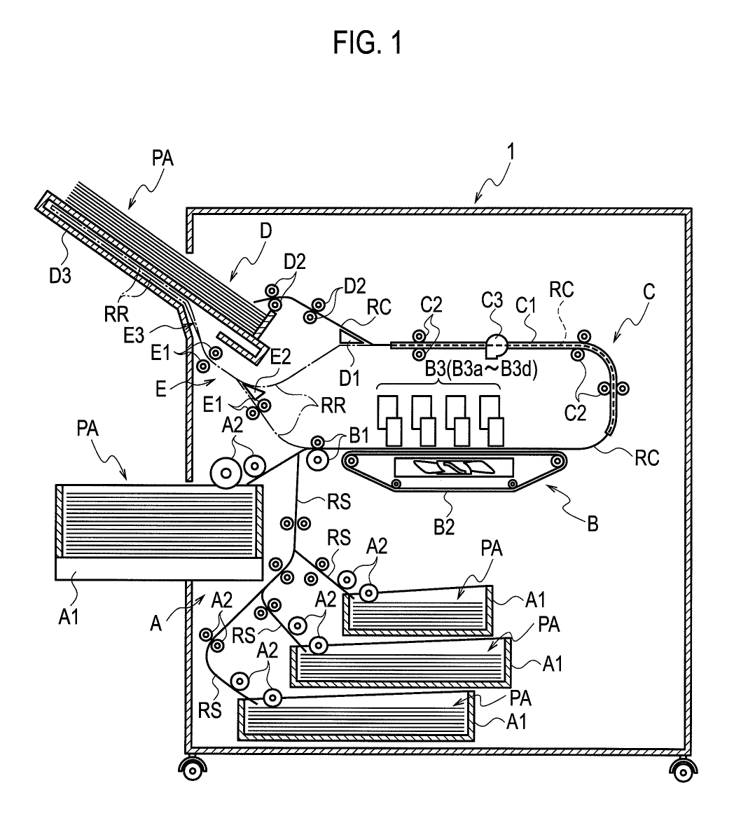

FIG. 8 is a block diagram showing a functional configuration of the inkjet printer of FIG. 1.

FIG. 9 is a diagram showing a relationship between a drive signal having a normal waveform and a change in pressure on the ink within the ink chamber of the inkjet head of FIG. 5 driven by the drive signal.

FIG. 10 is a diagram showing a relationship between an example of a drive signal having a residual vibration suppression waveform and a change in pressure on the ink within the ink chamber of the inkjet head of FIG. 5 driven by the drive signal.

FIGS. 11A and 11B are diagrams each showing a relationship between another example of a drive signal having a residual vibration suppression waveform and a change in pressure on the ink within the ink chamber of the inkjet head of FIG. 5 driven by the drive signal.

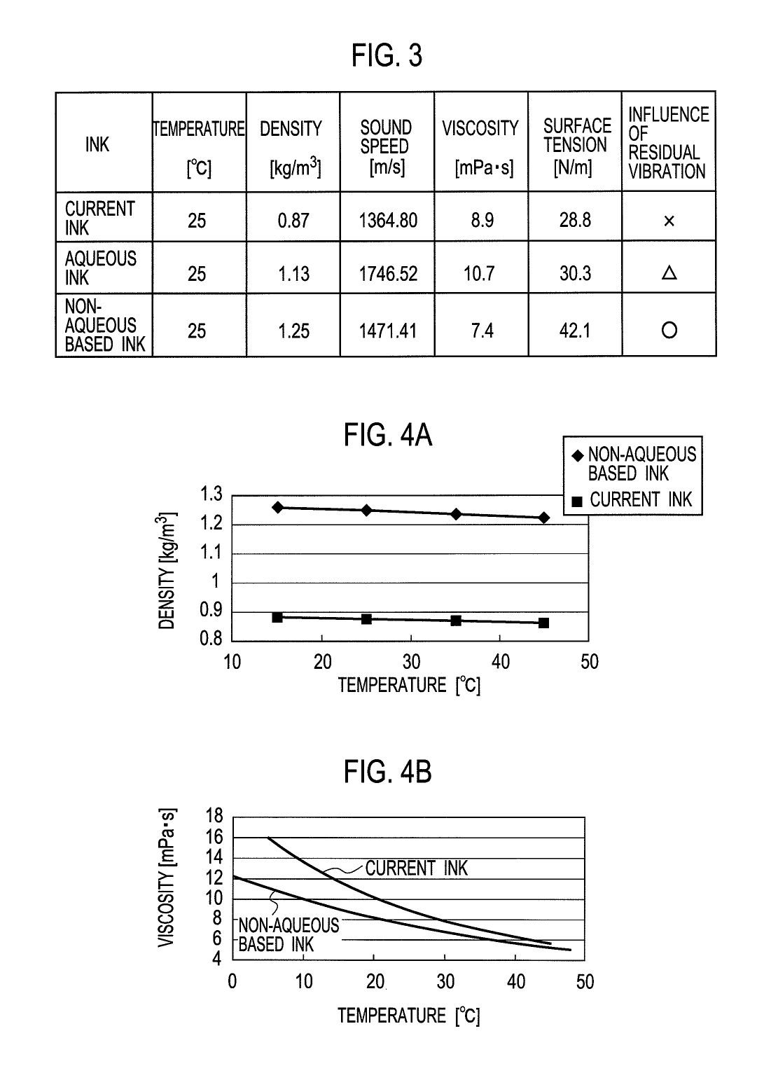

FIG. 12 is a diagram showing a physical quantity (density/viscosity) at different temperatures of the non-aqueous based ink and the current ink (oil ink) of FIG. 3.

FIG. 13 is a flowchart showing a procedure of processing relating to waveform selection of a drive signal to be performed by a CPU of a control unit of FIG. 8 in accordance with a program stored in a ROM.

FIG. 14 is a diagram showing a general configuration of another example of each ink circulation system printing unit of FIG. 1.

### DESCRIPTION OF THE EMBODIMENTS

Several embodiments of the present invention will be explained below with reference to the accompanying drawings. FIG. 1 is a diagram showing an outline of a configuration of an inkjet printer according to an embodiment of the present invention. As shown in FIG. 1, an inkjet printer (inkjet recording apparatus) 1 of the present embodiment includes a sheet feeder A, a printer B, a dryer C, a sheet discharge unit D, and a reverse unit E.

The sheet feeder A feeds a recording sheet PA. The sheet feeder A is arranged at the uppermost stream side of the transfer path indicated by the thick line of FIG. 1. The sheet feeder A includes a plurality of sheet feed tables A1 and a plurality of pairs of sheet feed rollers A2. The sheet feed roller A2 transfers the recording sheet PA from any of the sheet feed tables A1 through a sheet feed path RS that follows the sheet feed table A1 and feeds the recording sheet PA to the printer B.

The printer B prints an image on the recording sheet PA while transferring the recording sheet PA. The printer B is arranged at the downstream side of the sheet feeder A. The printer B includes a registration roller B1, a belt transfer unit B2, and five ink circulation system printing units B3 (B3a to B3e) corresponding to each color of CMYK. Each of the ink circulation system printing units B3a to B3e has an inlet head 5 (see FIG. 5) in the ink circulation path thereof.

The registration roller B1 transfers the recording sheet PA transferred from the sheet feeder A or the reverse unit E to the belt transfer unit B2. The belt transfer unit B2 transfers the recording sheet PA transferred from the registration roller B1 to the dryer C while attracting the recording sheet PA.

The dryer C transfers the printed recording sheet PA while drying the recording sheet PA. The dryer C is arranged at the downstream side of the printer B. The dryer C includes a drying furnace C1, three pairs of transfer rollers C2, and a heated air sending unit C3.

The drying furnace C1 stores heated gas sent from the heated air sending unit C3 while guiding the recording sheet PA. Inside of the drying furnace C1, a transfer space (not shown schematically) configuring part of a normal path RC indicated by the solid line and the broken line of FIG. 1 of the transfer path of the recording sheet PA is formed. The transfer roller C2 transfers the recording sheet PA inside of the drying furnace C1.

The sheet discharge unit D discharges and stacks the printed recording sheet PA. The sheet discharge unit D is arranged at the downstream side of the dryer C. The sheet discharge unit D is arranged at the most downstream side of the normal path RC. The sheet discharge unit D includes a switch mechanism D1, two pairs of sheet discharge rollers D2, and a sheet discharge table D3.

The switch mechanism D1 switches the transfer path of the recording sheet PA between the normal path RC and a reverse path RR for duplex printing indicated by the alternate long and short dash line of FIG. 1. The sheet discharge roller D2 discharges the recording sheet PA to the sheet charge table D3.

The reverse unit E reverses the recording sheet PA one side of which is printed and transfers the reversed recording sheet PA to the printer B. The reverse unit E includes a plurality of pairs of reverse rollers E1, a flipper E2, and a switch back unit E3.

The reverse roller E1 once transfers the recording sheet PA one side of which is printed transferred from the dryer C to the switch back unit E3 via the switch mechanism D1. Further, the reverse roller E1 transfers the recording sheet PA returned from the switch back unit E3 to the printer B via the flipper E2.

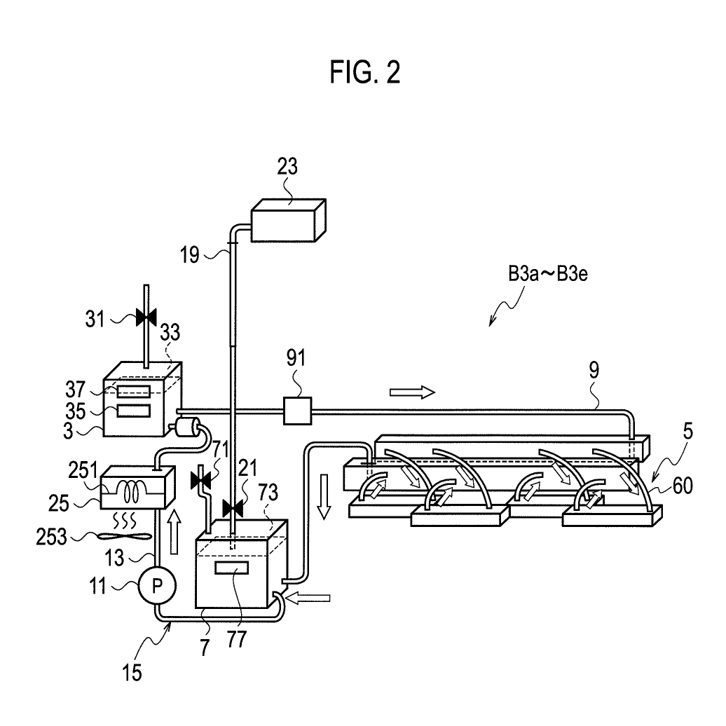

FIG. 2 is a diagram showing a general configuration of each ink circulation system printing unit of FIG. 1. Each of the ink circulation system printing units B3a to B3d shown in FIG. 2 performs printing on the recording sheet PA using an ink of each color of K (black), C (cyan), Y (yellow), and M (magenta). The other ink circulation system printing unit B3e performs printing on the recording sheet PA using an ink of K (black), the specifications of which differ from those of the ink circulation system printing unit B3a.

Each of the ink circulation system printing units B3a to B3e of FIG. 2 has an ink circulation path 15 configured by an ink flow path 9 from an upper tank 3 to a lower tank 7 through the inkjet head 5 and an ink flow path 13 from the lower tank 7 to the upper tank 3 through a circulation pump 11.

The upper tank 3 has an air layer 33 communicated with the atmosphere via an atmosphere open valve 31 inside thereof. The air layer 33 is provided as a buffer configured to buffer the pulsation that occurs in the pressure on the ink circulating through the ink circulation path 15 by the operation of the circulation pump 11 and to stabilize the pressure of the ink meniscus of the nozzle provided in the inlet head 5. Further, in the upper tank 3, two liquid surface sensors 35 and 37 configured to detect an upper limit value and a limit value above the upper limit value of the ink liquid surface inside thereof are provided.

On the way of the ink flow path 9, a temperature sensor 9 configured to detect the temperature of the ink passing through the ink flow path 9.

The inkjet head 5 has a plurality of blocks provided with a nozzle 57 (see FIG. 5) and is arranged below the upper tanker 3. To each of the nozzles 57 of the inkjet head 5, ink is supplied from the upper tank 3 via the ink flow path 9 with a pressure in accordance with the difference in the water head between the ink liquid surface of the upper tank 3 and the ink meniscus of the nozzle.

The lower tank 37 is arranged below the inlet head 5 and excessive ink from the inkjet head 5 is recovered by its own weight. The lower tank 7 has an air layer 73 communicated with the atmosphere via an atmosphere open valve 71 inside thereof. The air layer 73 is provided in order to stabilize the pressure of the ink meniscus of the nozzle by the atmosphere during the suspension of circulation of ink in the ink circulation path 15.

Further, in the lower tank 7, a liquid surface sensor 77 configured to detect a lower limit value of the ink liquid surface inside thereof. Furthermore, to the lower tank 7, an ink cartridge 23 is connected via a replenishing ink flow path 19 and an open/close valve 21. The ink cartridge 23 of each of the ink circulation system printing units B3a to B3d is filled with an ink in one of the process colors K (black), C (cyan), Y (yellow), and M (magenta). The ink cartridge 23 of the ink circulation system printing unit B3e is filled with the K (black) ink. However, the K (black) ink with which the ink cartridge 23 of the ink circulation system printing unit B3a is filled has specifications different from those of the K (black) ink with which the ink cartridge 23 of the printing unit B3e is filled.

When it is detected that the liquid surface of the ink in the lower tank 7 is reduced to the lower limit value by the liquid surface sensor 77, the open/close valve 21 is opened appropriately and the ink within the ink cartridge 23 is supplied by an appropriate amount to the lower tank 7 via the replenishing ink flow path 19.

The circulation pump 11 causes the ink in the lower tank 7 to reflow to the upper tank 3 via the ink flow path 13. On the way of the ink flow path 13, a temperature adjuster 25 is provided. This temperature adjuster 25 adjusts the temperature of the ink caused to reflow from the lower tank 7 to the upper tank 3 by the circulation pump 11 to an appropriate temperature at which the ink is ejected at an appropriate eject speed in the inkjet head 5. To this end, the temperature adjuster 25 has a heater 251 for heating, a fan 253 for cooling, and a heat sink.

Then, when switching the K (black) ink to the other ink having different specifications, it is only required to change the ink to use in printing from either of the ink circulation system printing units B3a and B3e to the other.

FIG. 3 is a diagram showing specifications of the ink with which each ink cartridge of FIG. 2 is filled. The ink cartridge 23 of each of the ink circulation system printing units B3a to B3d is filled with one of the current ink (oil ink) and the aqueous ink in FIG. 3. The ink cartridge 23 of the other ink circulation system printing unit B3e is filled with the non-aqueous based ink in FIG. 3 the same K (black) as that in the ink cartridge 23 of the ink circulation system printing unit B3a.

Here, the non-aqueous based ink of the present embodiment is a non-aqueous based ink including at least pigment and organic solvent and an ink including 50 wt % or more of cyclic carbonate (five-membered heterocyclic compound having the C═O bond) in the organic solvent and in which the content of the polymer component in the ink is 20 wt % or less of the pigment.

Further, the current ink (oil ink) is a general oil pigment ink in which pigment is dispersed in a water insoluble solvent and the aqueous ink is a general aqueous pigment ink in which pigment is dispersed in a base medium.

As shown in FIG. 3, the density of the non-aqueous based ink at 25° C. is higher than that of the current ink and the aqueous ink and the viscosity of the non-aqueous based ink at 25° C. is lower than that of the current ink and the aqueous ink. The non-aqueous based ink having a high density tends to remain for a long period of lime because the pressure fluctuation caused by the start of ejection of ink does not attenuate for a long period of time, and therefore the influence of the residual vibration is very great (“∘” in FIG. 3).

In general, the ink having a high density or the ink having a low viscosity tends to remain for a long period of time because the pressure fluctuation caused by the start of ejection of ink does not attenuate for a long period of time, and therefore it can be said that the influence of the residual vibration is very great.

When the influence of the residual vibration is great, unless the residual vibration of the ink within an ink chamber 56B is attenuated over a long period of time after ejection of the ink from the nozzle 57, the next ink is not ejected with an appropriate pressure, and therefore the printing quality is reduced. In other words, the time necessary for the ejection condition of the next ink to be made ready is lengthened.

On the other hand, in the current ink having a low density and a low viscosity at 25° C., the pressure fluctuation caused by the start of ejection of ink tends to attenuate comparatively and the influence of the residual vibration described above is substantially zero (“x” in FIG. 3). In the aqueous ink having a high viscosity at 25° C., the pressure fluctuation caused by the start of ejection of ink hardly tends to attenuate, although not so hardly as in the case of the non-aqueous based ink having a higher density, and therefore there is an influence of somewhat magnitude of the residual vibration (“Δ” in FIG. 3).

FIG. 4 shows a change in physical properties depending on temperature of the non-aqueous based ink and the current ink of FIG. 3, wherein FIG. 4A is a graph showing a change in density and FIG. 4B is a graph showing a change in viscosity. As shown in FIG. 4A, for both the non-aqueous based ink and the current ink, the density maintains substantially a constant value regardless of the temperature change. On the other hand, for both the non-aqueous based ink and the current ink, the viscosity reduces as temperature rises. In particular, the reduction rate of viscosity relative to the temperature change is larger in the current ink than in the non-aqueous based ink.

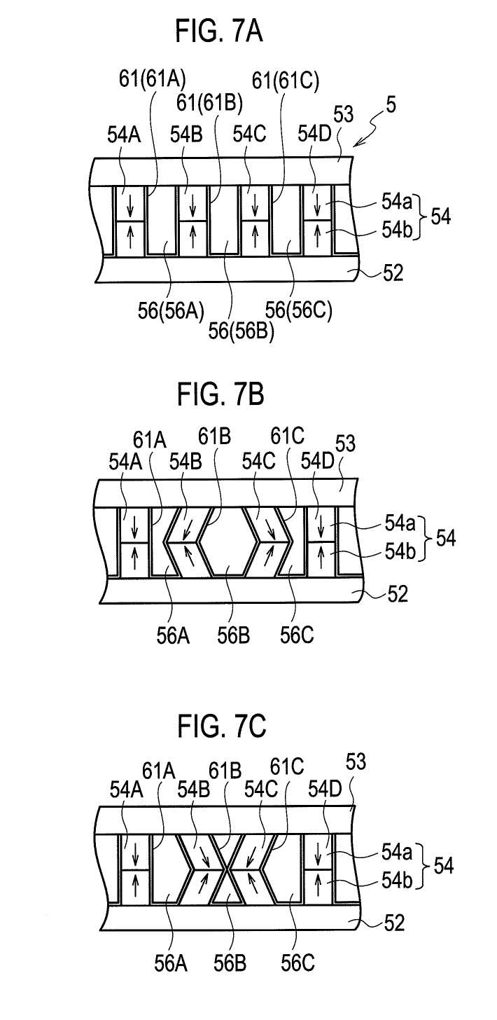

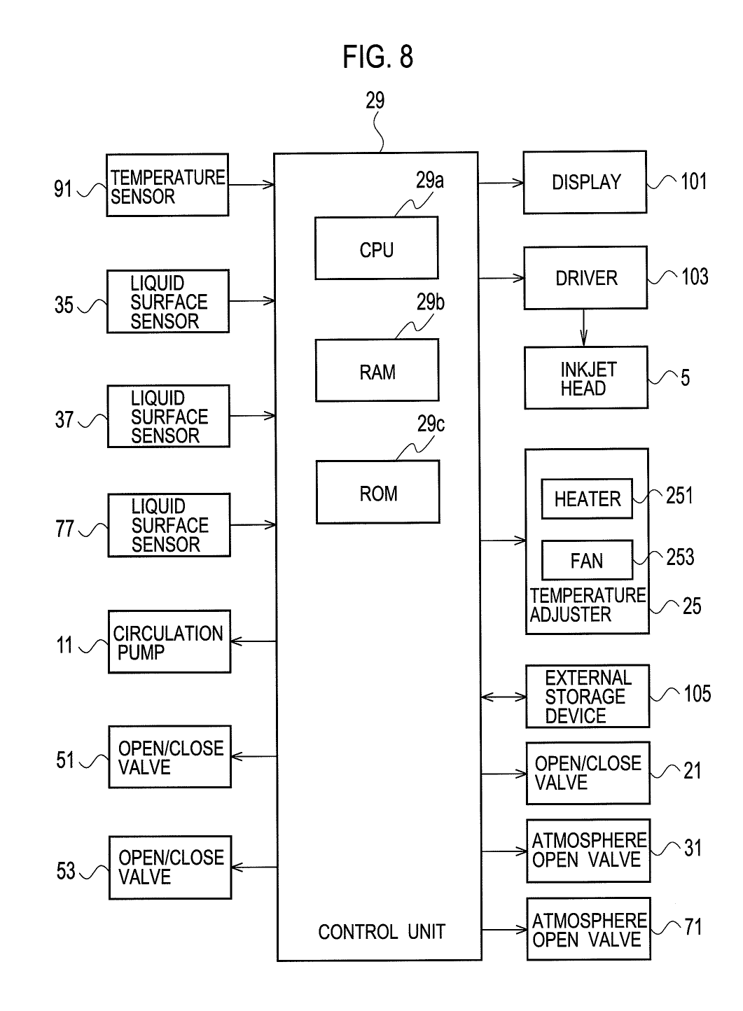

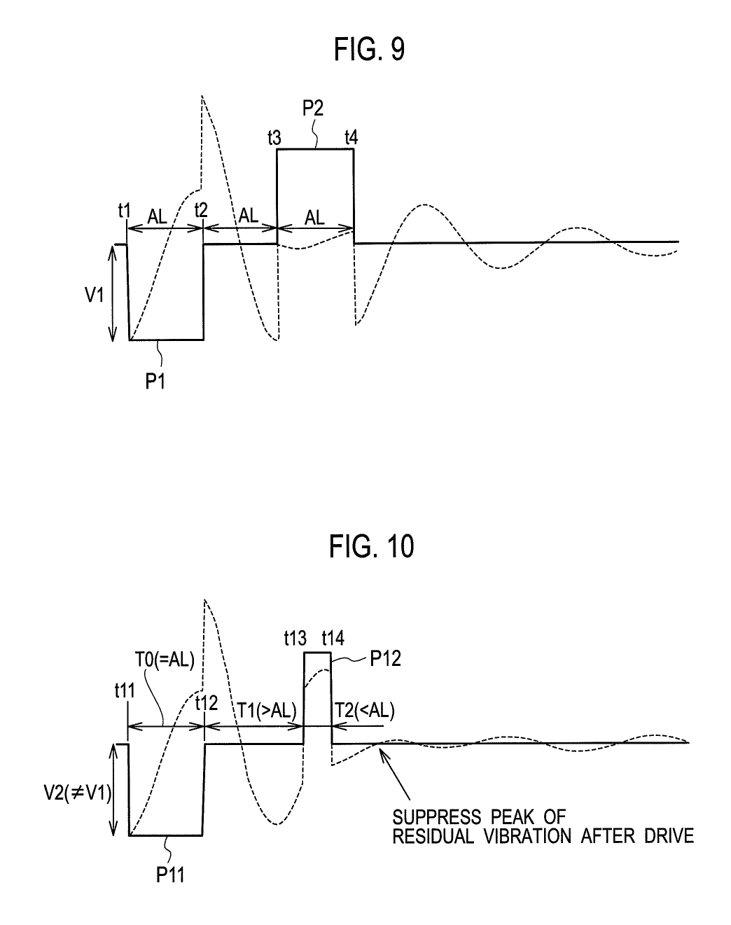

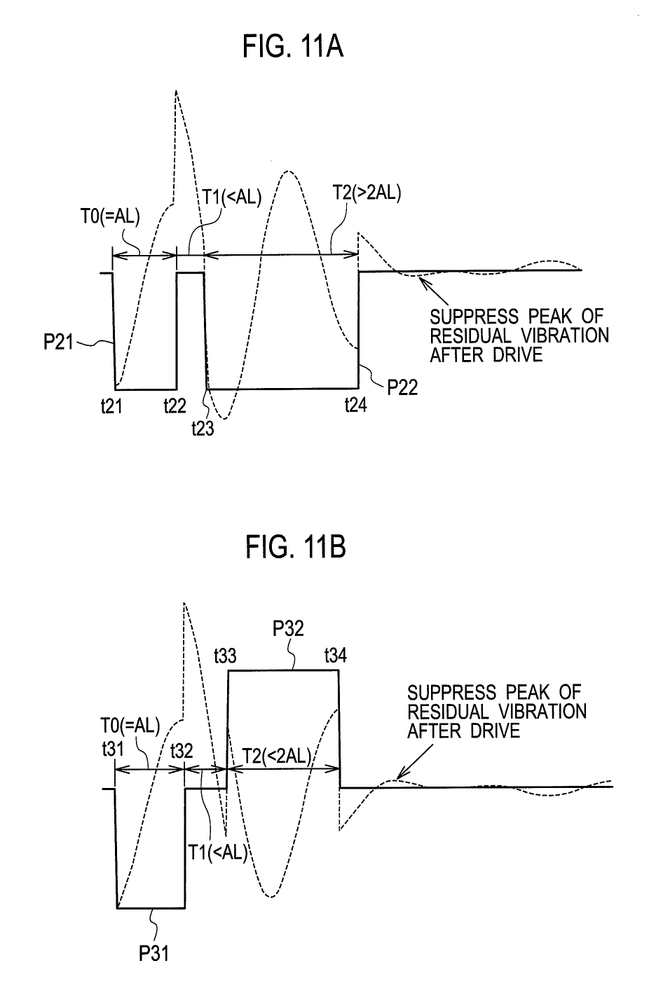

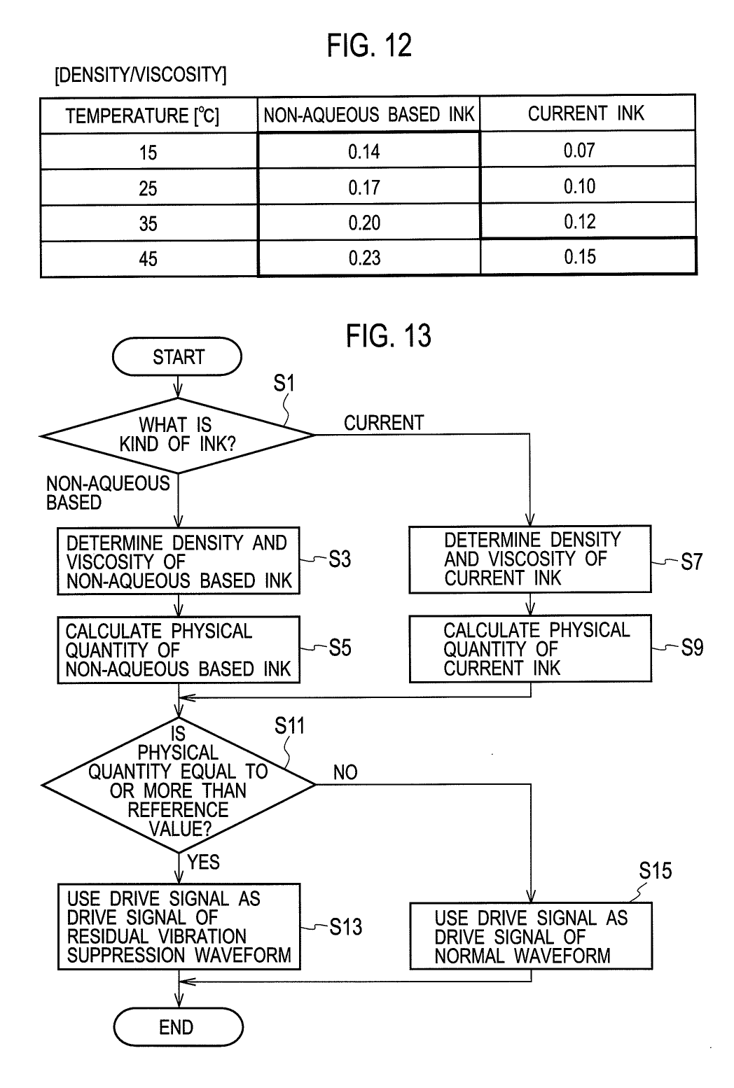

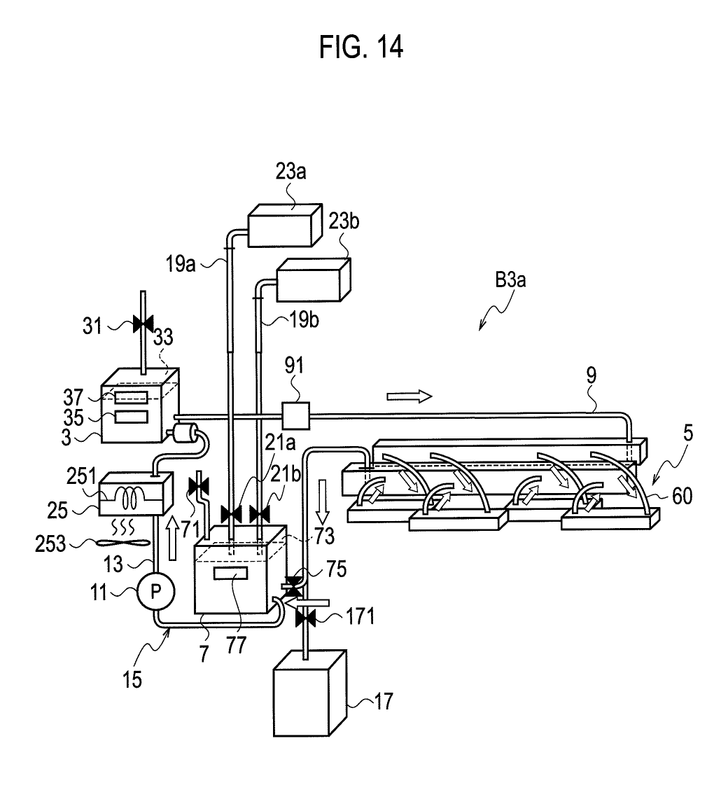

FIG. 5 is a perspective view showing an outline of a configuration of the inkjet head of FIG. 2 in a partial section, FIG. 6 is a section view along VI-VI line of the ink supply unit of the inkjet head shown in FIG. 5, and FIGS. 7A to 7C are each a section view along VII-VII line of the supply unit of the inkjet head shown in FIG. 5, showing the change of the state within the ink chamber at the time of ink ejection operation. The inkjet head shown in FIG. 5 is a share mode type inkjet head.

The configuration of the ink chamber in the present embodiment is common to all the ink chambers, and therefore the ink chamber will be represented hereinafter with its subscript omitted sometimes, such as an alphabet as a symbol denoting each ink chamber.

As shown in FIG. 5 to FIG. 7, in the inkjet head 5, a plurality of partition walls 54 including two piezoelectric members (volume changers) 54a and 54b is arranged between a substrate made of ceramic etc. and a cover plate 53. The piezoelectric members 54a and 54b are made of a publicly-known piezoelectric material, such as PZT (PbZrO₃—PbTiO₃), and polarized in different directions as shown by arrows in FIG. 7.

As shown in FIG. 5 and FIG. 6, on the front end of the substrate 52, the cover plate 53, and the partition wall 54, a nozzle plate 55 is fixed. Due to this, as shown in FIG. 7, a plurality of ink chambers 56 surrounded by the substrate 52, the cover plate 53, the partition wall 54, and the nozzle plate 55 is formed side by side.

As shown in FIG. 5 and FIG. 6, in the nozzle plate 55, a plurality of the nozzles 57 is provided and one end side of the ink chamber 56 is communicated with the nozzle 57. The other end side of the ink chamber 56 is communicated with an ink tube 60 through an ink inflow port 58 communicated with all the ink chambers 56 and an ink supply port 59 as shown in FIG. 6.

As shown in FIG. 2, the ink tube 60 is connected to the ink flow path 9 of the ink circulation path 15 of each of the ink circulation system printing units B3 (B3a to B3d) of FIG. 1 and the ink supplied to the lower tank 7 from one of ink cartridges 23a and 23b is supplied through the ink circulation path 15.

As shown in FIG. 7, at the partition wall 54 configuring the side surface of the ink chamber 56 and at the surface of the substrate 52 configuring the bottom surface, an electrode (variable unit) 61 is formed closely. The electrode 61 within an ink chamber 56 extends up to the surface on the rear side of the piezoelectric member 54a. To each of the electrodes 61, a flexible cable 62 is connected via an anisotropic conductive film (not shown schematically) on the surface of the rear side and via the flexible cable 62, a drive voltage by the drive signal is applied to the electrode 61.

When a drive voltage is applied to the electrode 61, the partition wall 54 undergoes shear deformation and changes the volume of the ink chamber 56 and the pressure within the ink chamber 56. Due to this, the ink within the ink chamber 56 is ejected from the nozzle 57.

FIG. 8 is a block diagram showing an electrical configuration of the inkjet printer 1 of FIG. 1. The inkjet printer 1 of the present embodiment has a control unit 29 for total control. The control unit 29 performs various kinds of control processing by a CPU 29a executing the program stored in a ROM 29c using a work region of a RAM 29b.

To the control unit 29, the temperature sensor 91 provided in the ink flow path 9 of the ink circulation system printing units B3a to B3e and each of the liquid surface sensors 35, 37, and 77 of the upper tank 3 and the lower tank 7 are connected.

Further, to the control unit 29, each of the atmosphere open valves 31 and 71 of the upper tank 3 and the lower tank 7, the circulation pump 11, the heater 251 and the fan 253 of the temperature adjuster 25, the open/close valve 21, and a display 101 provided in the inkjet printer 1 to display various kinds of information.

Furthermore, to the control unit 29, a driver 103 of the inkjet head 5 of each of the ink circulation system printing units B3a to B3e and an external storage device 105, such as a hard disk, are connected.

The driver 103 performs an ejection drive to eject ink from the nozzle 57 by applying the drive voltage to the electrode 61 of the inkjet head 5 via the flexible cable 62 to deform the partition wall 54 and thereby to change the volume of the ink chamber 56 and the pressure within the ink chamber 56.

The external storage device 105 stores waveform data of the normal waveform and the residual vibration suppression waveform of the voltage to drive the inkjet head 5. The normal waveform and the residual vibration suppression waveform are described later.

Further, the external storage device 105 stores data of the kinds of ink (for example, non-aqueous based ink, current ink (oil ink), aqueous ink, etc.) with which the ink cartridge 23 of FIG. 2 is filled and data of the kind of ink currently used in printing of the ink cartridge 23 of each of the ink circulation system printing units B3a and B3e as to K (black). It is possible to input and set the data of the kind of ink with which the ink cartridge 23 of each of the ink circulation system printing units B3a to B3e is filled from, for example, an operation panel, not shown schematically, of the inkjet printer 1. It is also possible to obtain the data of the kind of ink currently in use as to K (black) from the data of the kind of ink to use input and specified from the operation panel.

Furthermore, the external storage device 105 stores a table showing the characteristic of change in physical properties (density, viscosity) depending on temperature of each kind of ink (non-aqueous based ink, current ink (oil ink), aqueous ink) explained previously with reference to FIGS. 4A and 4B.

The CPU 29a of the control unit 29 selects which to use as the waveform of the drive signal between the normal waveform and the residual vibration suppression waveform using the detection result of the temperature sensor 91, the data of the kind of ink currently in use in printing of K (black) of the ink of the ink cartridge 23 of each of the ink circulation system printing units B3a and B3e, etc. Then, the CPU 29a controls the driver 103 so as to output the drive signal having the selected waveform to the electrode 61 of the inkjet head 5. This drive signal is output by the driver 103 to an electrode 61B of the ink chamber 56B each time one drop of ink is ejected. Further, the CPU 29a controls the adjustment of temperature of ink by the temperature adjuster 25.

Next, the basic operation of ink ejection is explained. In the following explanation, the turning on of a pulse signal in the drive signal is sometimes referred to as start of application and the turning off as end of application.

A case is explained where ink is ejected from the ink chamber 56B of three ink chambers 56A to 56C partitioned by partition walls 54A to 54D including the piezoelectric members 54a and 54b as shown in FIGS. 7A to 7C. FIG. 9 is a diagram showing a relationship between the drive signal having the normal waveform and the change in pressure of ink within the ink chamber of the inkjet head of FIG. 5 driven by this drive signal. In FIG. 9, the solid line indicates the waveform of the drive signal and the broken line indicates the pressure of ink within the ink chamber.

When the drive signal indicated by the solid line of FIG. 9 is supplied to the inlet head 5 from the CPU 29a of FIG. 8 in the stationary state shown in FIG. 7A, at time t1 in FIG. 9, electrodes 61A and 61C of the ink chambers 56A and 56C are grounded and at the same time, to the electrode 61B of the ink chamber 56B, a drive pulse P1 having a negative voltage (−V1) is applied. Then, an electric field is generated, which is in a direction perpendicular to the polarization direction of the piezoelectric members 54a and 54b configuring the partition walls 54B and 54C. Due to this, shear deformation occurs at the joint face of the piezoelectric members 54a and 54b and as shown in FIG. 7B, the partition walls 54B and 54C deform in the direction in which the partition walls 54B and 54C become more distant from with each other, and therefore the volume of the ink chamber 56B increases. As a result, the pressure of ink within the ink chamber 56B reduces and ink flows to the ink chamber 56B from the ink inflow port 58.

The application time of the drive pulse P1 is a period of time of AL (Acoustic Length) from time t1 to time t2. The acoustic length is the period of time until the pressure waveform, which is caused by the inflow of ink to the ink chamber 56 the volume of which has increased, propagates through the entire region of the ink chamber 56 and reaches the nozzle 57, that is, ½ of the acoustic resonance period of the ink chamber 56. The acoustic length is determined depending on the structure of the inkjet head 5, the sound speed of ink, etc.

Subsequently, at time t2 in FIG. 9, the voltage applied to the electrode 61B of the ink chamber 56B is returned to the ground potential from the state of FIG. 7B. Then, the partition walls 54B and 54C return to the neutral position shown in FIG. 7A. Due to this, the ink within the ink chamber 56B is pressurized and the ink is ejected from the corresponding nozzle 57.

When the period of time of AL elapses after the voltage applied to the electrode 61B of the ink chamber 56B is returned to the ground potential, during the period of time of AL from time t3 to time t4, a drive pulse P2 having a positive voltage is applied to the electrode 61B of the ink chamber 56B. Due to this, as shown in FIG. 7C, the partition walls 54B and 54C deform in the direction in which both come close to each other and the volume of the ink chamber 56B reduces.

After the application of the drive pulse P2, between time t4 and time t5 (not shown schematically), the voltage applied to the electrode 61B of the ink chamber 56B is set to the ground potential to return the state to the state of FIG. 7A.

As described above, the normal waveform is a waveform of the voltage applied to the electrode 61 so as to deform the partition wall 56 so that after the volume of the ink chamber 56 is increased, the volume is returned to the original volume and the volume is reduced, and then, the volume is returned again to the original volume.

It is not possible for the share mode type inkjet head 5 to drive the neighboring ink chambers 56 into the ejection operation at the same time because ink is ejected by making use of deformation of the partition wall 54 as described above. Because of this, at the time of recording operation, the time division drive is performed, in which all the ink chambers 56 possessed by the inkjet head 5 are divided into a plurality of groups of the ink chambers 56 not neighboring one another and the ink chambers 56 are driven into the ejection operation for each group.

The above-described inkjet printer 1 is also provided with, in addition to the normal waveform, the residual vibration suppression waveform, which is a waveform of the voltage to drive the electrode 61 so as to suppress the peak of the residual vibration after the ejection drive is completed more than in the case where the normal waveform is used.

An example of the residual vibration suppression waveform is shown in FIG. 10. FIG. 10 is a diagram showing a relationship between an example of the drive signal having the residual vibration suppression waveform and the change hi pressure of ink within the ink chamber of the inkjet head of FIG. 5 driven by this chive signal. In FIG. 10, the solid line indicates the waveform of the drive signal and the broken line indicates the pressure of ink within the ink chamber.

In the case where this residual vibration suppression waveform is used, in the stationary state shown in FIG. 7A, when the drive signal indicated by the solid line of FIG. 10 is supplied to the inkjet head 5 from the head drive unit 21 of FIG. 8, at time t11 in FIG. 10, the electrodes 61A and 61C of the ink chambers 56A and 56C are grounded and at the same time, a drive pulse P11 having a negative voltage (−V2≠−V1) is applied to the electrode 61B of the ink chamber 56B. Due to this, as shown in FIG. 7B, the partition walls 54B and 54C deform in the direction in which both become more distant from each other and the volume of the ink chamber 56B increases. As a result of this, the pressure of ink within the ink chamber 56B reduces and ink flows into the ink chamber 56B from the ink inflow port 58.

Subsequently, at time t12 when time T0 (=AL) elapses from time t11 in FIG. 10, the voltage applied to the electrode 61B of the ink chamber 56B is returned to the ground potential. Then, the partition walls 54 B and 54C return to the neutral position shown in FIG. 7A from the state of FIG. 7B. Due to this, the ink within the ink chamber 56B is pressurized and the ink is ejected from the corresponding nozzle 57.

At time t13 when time T1 (>AL) elapses after time t12 when the voltage applied to the electrode 61B of the ink chamber 56B is returned to the ground potential, the electrodes 61A and 61C of the ink chambers 56A and 56C are grounded and at the same time, a drive pulse (cancel pulse) P12 having a positive voltage is applied to the electrode 61B of the ink chamber 56B. Due to this, as shown in FIG. 7C, the partition walls 54 B and 54C deform in the direction in which both come close to each other and the volume of the ink chamber 56B reduces.

Before the drive pulse P12 having a positive voltage is applied to the electrode 61B of the ink chamber 56B, the ink pressure within the ink chamber 56B reduces by the reaction of ejection of ink from the nozzle 57 and after the peak, the ink pressure is increasing toward the normal pressure.

Then, by applying the drive pulse P12 before the pressure returns to the normal pressure to reduce the volume within the ink chamber 56B, and thereby, to generate a pressurizing force, the ink pressure within the ink chamber 56B exceeds the normal pressure toward the peak of the increase.

Further, at time t14 (time when time T2 (<AL) elapses after the drive pulse P12 is turned on (time t13)) immediately before the pressure of ink within the ink chamber 56B reaches the peak of the increase, the chive pulse P12 is turned off and the voltage applied to the electrode 61B of the ink chamber 56B is returned to the ground potential. Then, the partition walls 54 B and 54C return to the neutral position shown in FIG. 7A. Due to this, the increase in the pressure of ink within the ink chamber 56B approaching the peak of the increase is attenuated by the reduction in pressure caused by the increase in volume of the ink chamber 56B.

By this attenuation, the magnitude of reduction in the pressure of ink within the ink chamber 56B that has switched from increase to reduction after exceeding the normal pressure becomes small, and due to this, the pressure of ink within the ink chamber 56B turns into a tendency to return to the normal pressure at an early time of point after the drive pulse P12 is turned off (time t14).

Consequently, in the case where a plurality of ink liquid drops is ejected continuously, it is possible to advance the timing at which the drive pulse P11 of the next drive signal can be turned on compared to that in the case of the normal waveform. Because of this, it is possible to improve the ejection performance when continuously ejecting ink liquid drops by ejecting the second and subsequent ink liquid drops more quickly with an appropriate pressure.

The residual vibration suppression waveform may be also modified to the waveforms shown in FIGS. 11A and 11B, respectively. For the residual vibration suppression waveform shown in FIG. 11A, during the period from time t21 to time t22 when time T0 (=AL) elapses, a drive pulse P21 having a negative voltage (−V2) similar to the drive pulse P11 in the drive signal of FIG. 10 is applied to the electrode 61B of the ink chamber 56B.

Then, at time t23 (when time T1 (<AL) elapses after the drive pulse P21 is turned off (at time t22)) immediately before the pressure of ink within the ink chamber 56B that has reduced by the reaction of the ejection of ink from the nozzle 57 returns to the normal pressure, the electrodes 61A and 61C of the ink chambers 56A and 56C are grounded and at the same time, a drive pulse (cancel pulse) P22 having a negative voltage is applied to the electrode 61B of the ink chamber 56B. Due to this, as shown in FIG. 7B, the partition walls 54B and 54C deform in the direction in which both become more distant from each other and the volume of the ink chamber 56B increases. Due to this, the pressure of ink within the ink chamber 56B, which is higher than the normal pressure, immediately reduces exceeding the normal pressure.

Further, at time t24 when time T2 (>2AL) elapses after the drive pulse P22 is turned on (at time t23), the drive pulse P22 is turned off and the voltage applied to the electrode 61B of the ink chamber 56B is returned to the ground potential. Then, the partition walls 54B and 54C return to the neutral position shown in FIG. 7A.

Then, during the period of time of T2 (>2AL) from time t23 when the drive pulse P22 is on to time t24, the pressure of ink within the ink chamber 56B reduces to a pressure lower than the normal pressure and then increases to a pressure higher than the normal pressure and reduces again to a pressure lower than the normal pressure. During the period of repetition of the increase and reduction in pressure, the ink chamber 56B maintains the state where the volume is increased, and therefore the pressure fluctuation of ink within the ink chamber 56B is attenuated and the peak at the time of increase and reduction in pressure reduces gradually.

After that, at time t24, the drive pulse P22 is turned off and the voltage applied to the electrode 61B of the ink chamber 56B is returned to the ground potential. Then, the partition walls 54B and 54C return to the neutral position shown in FIG. 7A.

By the turning off of the drive pulse P22, the pressure within the ink chamber 56B increases immediately from the peak of reduction and exceeds the normal pressure. However, by this time, the pressure fluctuation of ink within the ink chamber 56B is attenuated, and therefore the magnitude of reduction after exceeding the nominal pressure is small. Consequently, the pressure of ink within the ink chamber 56B turns into a tendency to return to the normal pressure at an early point of time after the drive pulse P22 is turned off (at time t24).

Further, for the residual vibration suppression waveform shown in FIG. 11B, during the period from time t31 to time t32 when tune T0 (=AL) elapses, a drive pulse P31 having a negative voltage (−V2) similar to the drive pulse P11 in the drive signal of FIG. 10 is applied to the electrode 61B of the ink chamber 56B.

Then, at time t33 (time when time T1 (<AL) elapses after the drive pulse P31 is turned off (at time t32)) when the pressure of ink within the ink chamber 56B that has reduced by the reaction of ejection of ink from the nozzle 57 reduces exceeding the normal pressure, the electrodes 61A and 61C of the ink chambers 56A and 56C are grounded and at the same time, a drive pulse (cancel pulse) P32 having a positive voltage is applied to the electrode 61B of the ink chamber 56B. Due to this, as shown in FIG. 7C, the partition walls 54 B and 54C deform in the direction in which both come close to each other and the volume of the ink chamber 56B reduces. Due to this, the pressure of ink within the ink chamber 56B, which is lower than the normal pressure, increases exceeding the normal pressure caused by the reduction in volume of the ink chamber 56B.

Further, when time T2 (AL<T2<2AL) elapses after the drive pulse P32 is turned on (at time t33), at time t34 in FIG. 11B, the drive pulse P32 is turned off and the voltage applied to the electrode 61B of the ink chamber 56B is returned to the ground potential. Then, the partition walls 54B and 54C return to the neutral position shown in FIG. 7A.

Then, during the period of time of T2 (AL<T2<2AL) from time t33 when the drive pulse P32 is on to time t34, the pressure of ink within the ink chamber 56B increases temporarily to a pressure higher than the normal pressure caused by the reduction in volume of the ink chamber 56B. However, it switches to reduction instantly and after reducing to a pressure lower than the normal pressure, switches to increase and increases to a pressure higher than the normal pressure.

After that, at time t34 when the pressure of ink within the ink chamber 56B reaches the peak of increase, the drive pulse P32 is turned off and the voltage applied to the electrode 61B of the ink chamber 56B is returned to the ground potential. Then, the partition walls 54B and 54C return to the neutral position shown in FIG. 7A. Due to this, the increase in the pressure of ink within the ink chamber 56B approaching the peak of increase is attenuated by the reduction in pressure caused by the increase in volume of the ink chamber 56B.

By this attenuation, the magnitude of the reduction in the pressure within the ink chamber 56B, which has switched from increase to reduction, after exceeding the normal pressure becomes small, and therefore the pressure of ink within the ink chamber 56B turns into a tendency to return to the normal pressure at an early point of time after the drive pulse P32 is turned off (at time t34).

As described above, the residual vibration suppression waveform is a waveform of the voltage applied to the electrode 61 so as to deform the partition wall 54 so that after the volume of the ink chamber 56 is increased by the drive pulses P11, P21, and P31, the volume is returned to the original volume and then; with an interval sandwiched in-between, which is longer or shorter than the period of time of AL, that is, ½ of the acoustic resonance period of the ink chamber 56, the volume of the ink chamber 56 is reduced (FIG. 9, FIG. 10, FIG. 11B) or increased (FIG. 11A) by the drive pulses P12, P22, and P32 having a pulse width shorter or longer than the period of time of AL and then; the volume is returned again to the original volume.

With the drive signal having the above-described normal waveform, the negative pressure generated within the ink chamber 56B after the ejection of ink by the turning on of the drive pulse P2 is suppressed and the tail of the ejected ink becomes hard to be pulled in toward the side of the nozzle 57 as indicated by the broken line of FIG. 9. Because of this, with the drive signal having the normal waveform, the amount of ink that is ejected tends to become larger than that in the case of the residual vibration suppression waveform, and therefore the drive voltage of the drive signal having the normal waveform tends to be set lower than that in the case of the residual vibration suppression waveform.

With the drive signal having the above-described residual vibration suppression waveform, as indicated by the broken lines of FIG. 10 and FIGS. 11A and 11B, the pressure fluctuation of ink within the ink chamber 56B is attenuated while the drive pulses P12, P22, and P32 are on, the timing at which the pressure of ink within the ink chamber 56B returns to the normal pressure is advanced, and the start of the ink ejection operation by applying the next drive signal is advanced.

As shown in FIG. 3 and FIG. 4, the density of the non-aqueous based ink is high throughout the entire temperature region. Because of this, as to the non-aqueous based ink, when pressure fluctuation occurs in the non-aqueous based ink within the ink chamber 56B accompanying the ejection from the nozzle 57, the time necessary for the next ink ejection condition to be made ready is lengthened because of the great influence of the residual vibration due to a high density.

On the other hand, the density of the current ink (oil ink) is low throughout the entire temperature band. However, when the temperature rises to 45° C., the viscosity reduces to substantially the same level as that of the non-aqueous based ink. Because of this, as to the current ink (oil ink) at 45° C., if the pressure fluctuation occurs in the current ink (oil ink) within the ink chamber 56B accompanying the ejection from the nozzle 57, the time necessary for the next ink ejection condition to be made ready is lengthened because of the great influence of the residual vibration due to a low viscosity.

Consequently, in the present embodiment, in order to take into consideration both an ink having a high density and an ink having a low viscosity affected greatly by the residual vibration, “density/viscosity” is defined as a physical quantity. If an appropriate reference value is set to the physical quantity, the value of the physical quantity exceeds the reference value when the density is high or the viscosity is low, and therefore it is possible to estimate that the ink has a high density or a low viscosity.

FIG. 12 is a diagram showing the physical quantity (“density/viscosity”) at different temperatures of the non-aqueous based ink and the current ink (oil ink) of FIG. 3. In the present embodiment, the above-described reference value is set to 0.13. This reference value may be one obtained experimentally. It may be also possible to set the reference value to a value, for which it has been confirmed by an experiment that when the physical quantity is equal to or less than the value, the influence of the residual vibration of the ink pressure is slight. In the present embodiment, the reference value is set to 0.13 and as a result of that, as shown in the portion surrounded by the thick frame of FIG. 12, the non-aqueous based ink in the entire temperature region and the current ink at 45° C. have the physical quantities exceeding the reference value.

Subsequently, the procedure of processing relating to waveform selection of the drive signal that the CPU 29a of the control unit 29 of FIG. 8 performs in accordance with the program stored in the ROM 29c is explained with reference to the flowchart of FIG. 13.

First, the CPU 29a checks the kind of ink currently in use supplied to the inkjet head 5 of each of the ink circulation system printing units B3a to B3e based on the data stored in the external storage device 105 (step S1). It is assumed here that the ink cartridge 23 of the ink circulation system printing unit B3a is filled with the current ink (oil ink) and the ink cartridge 23 of the ink circulation system printing units B3e is filled with the non-aqueous based ink.

When the ink currently in use is the non-aqueous based ink (“non-aqueous based” at step S1), the CPU 29a determines the density and viscosity of the non-aqueous based ink based on the detected temperature by the temperature sensor 91 in the ink flow path 9 and the table of the external storage device 105 (step S3) and calculates the physical quantity of the non-aqueous based ink defined as “density/viscosity” (step S5).

On the other hand, when the ink currently in use is the current ink (oil ink) (“current” in step S1), the CPU 29a determines the density and the viscosity of the current ink based on the detected temperature by the temperature sensor 91 in the ink flow path 9 and the table of the external storage device 105 (step S7) and calculates the physical quantity of the current ink defined as “density/viscosity” (step S9).

Then, the CPU 29a checks whether or not the physical quantity of the ink (non-aqueous based ink or current ink) currently in use calculated at step S5 or step S9 is equal to or more than the reference value (in the present embodiment, 0.13) (step S11). When the physical quantity is equal to or more than the reference value (YES at step S11), the drive signal having the residual vibration suppression waveform is used as the drive signal applied to the inkjet head 5 by the driver 103 (step S13). On the other hand, when the physical quantity is less than the reference value (NO at step S11), the drive signal having the normal waveform is used as the drive signal applied to the inkjet head 5 by the driver 103 (step S15).

The CPU 29a performs each procedure described above periodically or when triggered by some factor. It is possible to seta case where the kind of ink with which the ink cartridge 23 of each of the ink circulation system printing units B3a to B3e is filled is input and set from the operation panel (not shown schematically), a case where a printing job is received from outside, etc., as a factor of the trigger.

As is also obvious from the above explanation, in the present embodiment, step S11 in the flowchart of FIG. 13 is the processing as a comparator of the CPU 29a. Further, in the present embodiment, the drive signal application unit is configured by the CPU 29a that performs the processing of step S13 and step S15 in FIG. 13 and the driver 103.

In the inkjet printer 1 of the present embodiment with the above-described configuration, when the non-aqueous based ink having a high density is used, the physical quantity defined as “density/viscosity” is equal to or more than the reference value, and therefore printing on the recording sheet PA is performed using the drive signal having the residual vibration suppression waveform.

Further, as to the current ink (oil ink), when the temperature of the ink is 45° C., the physical quantity defined as “density/viscosity” is equal to or more than the reference value, and therefore printing on the recording sheet PA is performed using the drive signal having the residual vibration suppression waveform. On the other hand, when the temperature of the ink is less than 45° C., the physical quantity is less than the reference value, and therefore printing on the recording sheet PA is performed using the drive signal having the normal waveform.

As described above, in the inkjet printer 1 of the present embodiment, when printing is performed using the ink having a high density or the ink having a low viscosity, which is affected greatly by the residual vibration of the ink that occurs in the ink chamber 56B after the ink is ejected from the nozzle 57, by using the drive signal having the residual vibration suppression waveform, it is possible to cancel the residual vibration of the ink of the ink chamber 56B at an early point of time and to improve the ejection performance in the case where ejection of ink is repeated at short time intervals.

In the embodiment described above, the two ink circulation system printing units B3a and B3e are provided in correspondence to K (black) and each of the ink cartridges 23 is filled with one of the current ink (oil ink) and the aqueous ink and the other is filled with the non-aqueous based ink, respectively. Then, the configuration is made so that the kinds of ink of K (black) used in printing are switched by switching the ink circulation system printing units B3a and B3e to use. However, it may be also possible to make the configuration in which two ink cartridges are connected to the tank of one ink circulation system printing unit and the kinds of ink used in printing are switched by switching the ink cartridges that supply ink to the tank.

The general configuration of the ink circulation system printing unit configured as described above is explained with reference to FIG. 14. In FIG. 14, the configuration described above is applied, in which two ink cartridges are connected, to the ink circulation system printing unit B3a corresponding to K (black).

The ink circulation system printing unit B3a of K (black) shown in FIG. 14 differs from the ink circulation system printing unit B3a of FIG. 2 in that to the lower tank 7, the two ink cartridges 23a and 23b are connected via replenishing ink flow paths 19a and 19b and open/close valves 21a and 21b.

Further, the ink circulation system printing unit B3a of FIG. 14 differs from the ink circulation system printing unit B3a of FIG. 2 in having a waste ink tank 17. The waste ink tank 17 is branched from a point on the way of the ink flow path 9 from the inlet head 5 to the lower tank 7 and connected via an open/close valve 171. In the ink flow path 9 between the branch point to the waste ink tank 17 and the lower tank 7, an open/close valve 75 is also interposed.

In the normal state where the ink is circulated through the ink circulation path 15 of the ink circulation system printing unit B3a with the configuration described above, the open/close valve 75 of the lower tank 7 is opened and at the same time, the open/close valve 171 of the waste ink tank 17 is closed. Further, when the ink circulating through the ink circulation path 15 is discharged to the outside of the ink circulation path 15 in accordance with the necessity, the open/close valve 75 of the lower tank 7 is closed and at the same time, the open/close valve 171 of the waste ink tank 17 is opened.

Then, when the color of the ink ejected by the inlet head 5 of the ink circulation system printing unit B3a is switched from one of the two ink cartridges 23a and 23b to the other, for example, the switching operation by the following method is performed.

In this switching operation, first one of the open/close valves 21a and 21b of the two replenishing ink flow paths 19a and 19b is opened and the other is closed. Due to this, the ink of the ink cartridge 23a (or the ink cartridge 23b) to use is supplied selectively to the lower tank 7.

Then, the open/close valve 75 of the lower tank 7 is opened at the same time as the open/close valve 171 of the waste ink tank 17 is closed to activate the circulation pump 11 and the ink of the lower tank 7 is circulated through the ink circulation path 15. Subsequently, the inkjet head 5 is caused to perform the ink ejection operation.

When switching the inks ejected by the inkjet head 5 of the ink circulation system printing unit B3a, the open/close states of the open/close valves 21a and 21b of the replenishing ink flow paths 19a and 19b are switched from the state where the ink before switch is supplied to the lower tank 7 to the state where the ink after switch is supplied to the lower tank 7.

At this time, if the open/close states of the open/close valves 21a and 21b of the replenishing ink flow paths 19a and 19b are switched when the ink before the switch remains in the ink circulation path 15, when the inkjet head 5 is caused to perform the ejection operation immediately after the switch, the ink before the switch is ejected for a while.

Consequently, it may be also possible to perform printing using the ink after the switch after performing preliminary printing until the ink before the switch is ejected no longer after the open/close states of the open/close valves 21a and 21b of the replenish ink flow paths 19a and 19b are switched.

In the case of the configuration having the ink circulation system printing unit B3a of FIG. 14, to the CPU 29a of the control unit 29 of the inkjet printer 1, the open/close valves 21a and 21b are connected in place of the open/close valve 21 shown in FIG. 8. Further, to the CPU 29a, the open/close valves 75 and 171 are connected. Then, the CPU 29a performs the same processing as that shown in the flowchart of FIG. 13 as to the waveform selection of the drive signal. With such a configuration, it is also possible to obtain the same effect as that in the case of the embodiment explained previously.

It may be also possible to apply the configuration in which one of the current ink (oil ink) and the aqueous ink and the non-aqueous based ink are switched and used in printing not only to K (black) described above but also to part or all of the colors of C (cyan), M (magenta), and Y (yellow). Here, when one with the configuration of FIG. 2 is used as an ink circulation system printing unit, a fifth or subsequent ink circulation system printing unit is provided appropriately as a result. Further, when one with the configuration of FIG. 14 is used, one of the ink circulation system printing units B3b to B3d of the corresponding color is made to have the configuration of FIG. 14 as a result.

In the present embodiment, which of the normal waveform and the residual vibration suppression waveform is used as the waveform of the drive signal is determined by the comparison between the physical quantity defined as “density/viscosity” and the reference value corresponding thereto. However, it may be also possible to define “density” or a value in proportion to “density” as a physical quantity. In that case, the configuration is made so that which of the normal waveform and the residual vibration suppression waveform is used as the waveform of the drive signal is determined by the comparison between a reference value and the above-mentioned physical quantity, the reference value being so set that, for example, in the case of the non-aqueous based ink, the physical quantity is equal to or more than the reference value and in the case of the current ink (oil ink) or the aqueous ink the density of which is lower than that of the non-aqueous based ink, the physical quantity is less than the reference value.

Specifically, when the physical quantity is equal to or more than the reference value (non-aqueous based ink), the drive signal having the residual vibration suppression waveform is used and when the physical quantity is less than the reference value (current ink (oil ink)), the drive signal having the normal waveform is used as a result.

Further, in the present embodiment, the non-aqueous based ink and the current ink are selected and used. However, it may be also possible, for example, to select and use a plurality of kinds of ink having different densities (or densities and viscosities), such as when selecting and using the non-aqueous based ink and the aqueous ink.

Furthermore, in the present embodiment, the inkjet printer 1 has the configuration in which the two kinds of ink are supplied selectively to the inkjet head 5. However, it is also possible to apply the present embodiment to an inkjet printer having a configuration in which three or more kinds of ink are supplied selectively to the inkjet head 5.

On the contrary, even for an inkjet printer not having a configuration in which a plurality of kinds of ink is supplied selectively to the inkjet head 5, if the configuration is such one in which the kind of ink supplied to the inkjet head 5 can be identified, it is made possible to select the waveform of the chive signal in accordance with the kind of ink supplied to the inkjet head 5.

As a configuration in which the kind of ink supplied to the inkjet head 5 is identified, it is possible to adopt, for example, a configuration in which data indicating the kind of ink supplied to the inkjet head 5 is registered in a memory, such as the external storage device 105, or a configuration in which the kind of ink is detected directly by a sensor or a barcode etc. indicating the kind of ink of an ink cartridge is read by a sensor and detected.

As explained above, the inkjet recording apparatus according to the above-mentioned embodiment has: a volume changer configured to eject ink from a nozzle by applying a chive signal to an ink chamber communicated with the nozzle to increase or decrease the pressure on the ink to be supplied to the ink chamber and thereby to change the volume of the ink chamber; a comparator configured to compare a physical quantity in proportion to the density of the ink to be supplied selectively to the ink chamber with a predetermined reference value; and a drive signal application unit configured to apply a drive signal including a cancel pulse to suppress the residual vibration of pressure of ink within the ink chamber to the volume changer when the physical quantity exceeds the reference value and at the same time, to apply a drive signal not including the cancel pulse to the volume changer when the physical quantity is less than the reference value, wherein the volume changer changes the volume of the ink chamber so that the pressure fluctuation of ink within the ink chamber after the application of the drive signal is completed is cancelled when the drive signal including the cancel pulse is applied.

When the density of ink supplied to within the ink chamber is high, the pressure fluctuation that occurs in the ink within the ink chamber after the ejection of ink from the nozzle is started becomes strong compared to that in the case where the density is low. Consequently, the timing at which it is made possible to give a pressure necessary to eject the next ink after the pressure fluctuation ceases to the ink by the change in volume of the ink chamber is delayed compared to that in the case where the density of the ink is low, and therefore the ejection performance when ejecting ink continuously is reduced.

Then, when the density of the ink supplied to within the ink chamber is high, the physical quantity in proportion to the density becomes prone to exceed the reference value. When the physical quantity exceeds the reference value, the drive signal including the cancel pulse to suppress the residual vibration of ink pressure within the ink chamber is applied to the volume changer and the volume of the ink chamber is changed by the volume changer after the ejection of ink from the nozzle is started. By the change in volume, the pressure fluctuation that has occurred in the ink within the ink chamber is cancelled immediately after the ejection of ink from the nozzle is started. Due to this, the ejection performance when ejecting ink continuously is improved.

Consequently, in the inkjet recording apparatus according to the present embodiment, it is possible to appropriately apply a cancel pulse intended to suppress residual vibration to ejection of ink by selecting a drive signal with appropriate contents in accordance with the density of the ink supplied to within the ink chamber and by applying the drive signal to the volume changer.

Further, in the inkjet recording apparatus according to the present embodiment, the physical quantity is defined as a quantity, which is the value of the density of the ink supplied selectively to the ink chamber divided by the value of the viscosity of the ink.

When the viscosity of the ink supplied to within the ink chamber is low, as in the case where the density is high, the pressure fluctuation that occurs in the ink within the ink chamber after the ejection of ink from the nozzle is started is strong compared to that in the case where the viscosity is high. Consequently, the timing at which it is made possible to give a pressure necessary to eject the next ink after the pressure fluctuation ceases to the ink by the change in volume of the ink chamber is delayed compared to that in the case where the viscosity of the ink is high, and therefore the ejection performance when ejecting ink continuously is reduced.

Then, when the viscosity of the ink supplied to within the ink chamber is low, the physical quantity, which is the value of the density of the ink divided by the value of the viscosity of the ink, becomes prone to exceed the reference value and the drive signal applied to the volume changer comes to include a cancel pulse to suppress the residual vibration of ink pressure within the ink chamber. Consequently, the pressure fluctuation that has occurred in the ink within the ink chamber is cancelled immediately after the ejection of ink from the nozzle is started by the cancel pulse included in the drive signal. Due to this, the ejection performance when ejecting ink continuously is improved.

Consequently, in the inkjet recording apparatus according to the present embodiment, it is possible to more appropriately apply a cancel pulse intended to suppress residual vibration to ejection of ink by selecting a drive signal with appropriate contents in accordance with the density and viscosity of the ink supplied to within the ink chamber and by applying the drive signal to the volume changer.

Further, the inkjet recording apparatus according to the above-mentioned embodiment further has: a table storage unit configured to store a table indicating a correspondence relationship between the value of the physical quantity and the temperature of ink for each ink; and a temperature detector configured to detect the temperature of the ink, wherein the comparator refers to the table corresponding to the ink supplied selectively to the ink chamber and compares the value of the physical quantity corresponding to the detected temperature of the temperature detector with the reference value, and the drive signal application unit determines the drive signal applied to the volume changer based on the comparison result of the comparator.

Consequently, according to the above-mentioned invention, the viscosity of ink changes depending on the temperature of the ink, and therefore it is possible to more appropriately apply a cancel pulse intended to suppress residual vibration to ejection of ink by selecting a drive signal with appropriate contents and applying the drive signal to the volume changer while taking into consideration the viscosity of the ink reflected in the value of the physical quantity on a table corresponding to the temperature of the ink detected by the temperature detector.

Further, the inkjet recording apparatus according to the above-mentioned embodiment, wherein the reference value is set to such a value so that the physical quantity of the non-aqueous based ink is equal to or more than the reference value when the ink supplied selectively to the ink chamber is the non-aqueous based ink including at least pigment and organic solvent and including 50 wt % or more of five-membered heterocyclic compound having the C═O bond in the organic solvent and in which the content of the polymer component in the ink is 20 wt % or less of the pigment.

The density of the non-aqueous based ink mentioned above is relatively higher than that of the general oil ink or aqueous ink and the pressure fluctuation that occurs in the ink within the ink chamber after the ejection of ink from the nozzle is started is strong, and therefore the ejection performance when ejecting ink continuously is reduced. Then, the physical quantity in proportion to the density of the non-aqueous based ink is always a value equal to or more than the reference value, and therefore, if the non-aqueous based ink is supplied to the ink chamber, the drive signal including a cancel pulse intended to suppress residual vibration is applied to the volume changer. Consequently, the pressure fluctuation that occurs in the non-aqueous based ink within the ink chamber after the ejection of ink from the nozzle is started is cancelled by the change in volume of the ink chamber by the volume changer in response to the application of the cancel pulse.

Consequently, in the inkjet recording apparatus according to the above-mentioned embodiment, it is possible to appropriately apply the cancel pulse intended to suppress residual vibration to the ejection of the non-aqueous based ink by selecting a drive signal with appropriate contents according to the density of the non-aqueous based ink and applying the drive signal to the volume changer when the non-aqueous based ink is supplied to within the ink chamber.

The present application claims the benefit of priority under 35 U.S.C §119 to Japanese Patent Application No. 2011-260524, filed on Nov. 29, 2011, the entire content of which is incorporated herein by reference.

What is claimed is:

1. An inkjet recording apparatus, comprising:
a volume changer configured to eject an ink from a nozzle by applying a drive signal to an ink chamber communicated with the nozzle to change the volume of the ink chamber and thereby to increase or decrease the pressure on the ink to be supplied to the ink chamber;
a comparator configured to compare a value of a physical quantity in proportion to the density of the ink to be supplied selectively to the ink chamber with a predetermined reference value; and
a drive signal application unit configured to apply a first drive signal to the volume changer, the first drive signal including a cancel pulse to suppress the residual vibration of the pressure on the ink within the ink chamber, when the physical quantity exceeds the reference value, or to apply a second drive signal not including the cancel pulse to the volume changer when the physical quantity is less than the reference value, wherein
when a first drive signal is applied, the volume changer changes the volume of the ink chamber so that the fluctuation of the pressure on the ink within the ink chamber after the application of the first drive signal is completed is cancelled.

2. The inkjet recording apparatus according to claim 1, wherein
the physical quantity is defined as a quantity, which is the density of the ink supplied selectively to the ink chamber divided by the viscosity of the ink.

3. The inkjet recording apparatus according to claim 2, further comprising:
a table storage unit configured to store a table indicating a correspondence between values of the physical quantity and values of the ink temperature for each type of ink; and
a temperature detector configured to detect the ink temperature, wherein
the comparator refers to the table corresponding to the ink supplied selectively to the ink chamber and compares the value of the physical quantity corresponding to the temperature detected by the temperature detector with the reference value, and the drive signal application unit decides which of a first drive signal and a second drive signal as the drive signal applied to the volume changer based on the comparison result of the comparator.

4. The inkjet recording apparatus according to claim 1, wherein
the reference value is set to a value so that the physical quantity of the non-aqueous based ink is equal to or more than the reference value when the ink supplied selectively to the ink chamber is the non-aqueous ink including at least pigment and organic solvent and including 50 wt % or more of five-membered heterocyclic compound having the C═O bond in the organic solvent and in which the content of the polymer component in the ink is 20 wt % or less of the pigment.
